(19) United States
(12) Patent Application Publication
(10) Pub. No.: US 2016/0142285 A1
(43) Pub. Date: May 19, 2016

(54) OPENFLOW SWITCH AND METHOD FOR PACKET EXCHANGING THEREOF, SDN CONTROLLER AND DATA FLOW CONTROL METHOD THEREOF

(71) Applicant: Industrial Technology Research Institute, Hsinchu (TW)

(72) Inventors: Yu-Wei Lee, Changhua County (TW); Tzi-Cker Chiueh, Taipei City (TW)

(21) Appl. No.: 14/582,205

(22) Filed: Dec. 24, 2014

Related U.S. Application Data
(60) Provisional application No. 62/079,486, filed on Nov. 13, 2014.

(51) Int. Cl. H04L 12/707; H04L 12/851; H04L 12/741; H04L 29/06

(52) U.S. Cl. CPC H04L 45/22; H04L 69/22; H04L 47/2441; H04L 45/745

(57) ABSTRACT

An OpenFlow switch, a packet exchanging method thereof, an SDN controller and a data flow control method thereof are provided. The OpenFlow switch includes a network unit, a storage unit and a processing unit. The network unit is connecting to a network, wherein the network at least includes Ethernet switches. The storage unit stores a flow table including action rules, and each of the action rules includes a condition and an action. The processing unit receives a packet, the processing unit analyzes the packet and determines whether the packet satisfies the condition of each of the action rules. If the processing unit determines that the packet satisfies the condition of a first action rule, the processing unit executes the action of the first action rule, which includes: substitutes a flow address for a destination MAC address of the packet, and transmits the packet to the network through the network unit.

### CROSS-REFERENCE TO RELATED APPLICATION

This application claims the priority benefits of U.S. provisional application Ser. No. 62/079,486, filed on Nov. 13, 2014. The entirety of the above-mentioned patent application is hereby incorporated by reference herein and made a part of this specification.

### TECHNICAL FIELD

The technical field relates to an OpenFlow switch, a method for packet exchanging thereof, a SDN controller and a data flow control method thereof.

### BACKGROUND

Owing to the heavy use of network, the routing technique in network has become a key point to make the best use of the network capacity. In conventional network structure (e.g., the network structure of Ethernet), each of the network devices (e.g., routers and switches) in the network would decide the next stop of a data packet when receiving a data packet. In other words, a data path of the data packet cannot be decided when transmitted. Since each of the network devices can only access the network devices nearby, so the decision made by each of the network device may be bad or lack efficiency in the view of the whole network structure. As a result, OpenFlow network that based on software-defined networking (SDN) has been developed by researchers to solve the problems of conventional network structure described above.

SDN is a technology that converts conventional hardware-based, inflexible, and closed network architectures into open programmable network architectures. In the network structure of the OpenFlow network, a SDN controller, that is connecting to the all the network devices in the OpenFlow network, is configured to manage the data paths of all the connections in the OpenFlow network by updating rules (i.e., flow control information such as output port, QoS, etc.) stored in the network devices (i.e., the OpenFlow switches) in the OpenFlow network, such that the network devices in the OpenFlow network could process the data packet based on the rules provided by the SDN controller. Since the SDN controller can control the data path of data packets in all connections of the OpenFlow network, the network capacity could be greatly improved.

However, in order to transfer an existing network into an OpenFlow network, the network devices in the OpenFlow network (e.g., the OpenFlow switches) need to be capable of interpreting the rules and network information sent from the SDN controller, which is a feature that the network devices in the existing network (e.g., Ethernet switches) are not compatible with. Furthermore, it takes time cost and hardware cost to replace all the network devices in the entire existing network into network devices that is compatible with the OpenFlow network structure. As a result, the coexisting of the OpenFlow network and the existing network has become an issue to be solved by people who have skills in the art.

### SUMMARY

In one of exemplary embodiments of the present disclosure, the OpenFlow switch includes but not limited to a network unit, a storage unit and a processing unit. The network unit is connecting to a network, wherein the network at least includes a plurality of Ethernet switches. The storage unit is coupled to the network unit and stores a flow table, wherein the flow table includes a plurality of action rules, and each of the action rules includes a condition and an action. The processing unit is coupled to the network unit and the storage unit. The processing unit receives a first packet, the processing unit analyzes the first packet and determines whether the first packet satisfies the condition of each of the action rules and if the processing unit determines that the first packet satisfies the condition of a first action rule of the action rules, the processing unit executes the action of the first action rule, wherein the action of the first action rule includes: substitutes a first flow address for a destination media access control (MAC) address of the first packet, and transmits the first packet to the network through the network unit.

In one of exemplary embodiments of the present disclosure, The method for packet exchanging, suitable for a OpenFlow switch that is connecting to a network including a plurality of Ethernet switches, includes but not limited to the steps of: receiving a first packet; analyzing the first packet and determining whether the first packet satisfies the condition of each of a plurality of action rules; and if the first packet satisfies the condition of a first action rule of the action rules, executing the action of the first action rule, wherein the action of the first action rule includes: substituting a first flow address for a destination media access control (MAC) address of the first packet, and transmitting the first packet to the network.

In one of exemplary embodiments of the present disclosure, the SDN controller includes but not limited to a network unit and a processing unit. The network unit is connecting to a network, wherein the network includes a plurality of Ethernet switches, a first OpenFlow switch and a OpenFlow second switch, wherein the first OpenFlow switch and the second OpenFlow switch are connecting to each other through the Ethernet switches. The processing unit is coupled to the network unit. Here, the processing unit monitors a connection between the first OpenFlow switch and the second OpenFlow switch through the network unit. The processing unit calculates to derive a data path of the connection according the connection and a network structure of the network. And, through the network unit, the processsing unit transmits a plurality of action rule to the first OpenFlow switch and the second OpenFlow switch and transmits a plurality of control signals to update a static forwarding table stored in each of the Ethernet switches on the data path, wherein, each of the action rules includes a condition and an action, and the action of a first action rule of the action rules includes: substituting a first flow address for a destination media access control (MAC) address of a packet that satisfies the condition of the first action rule, and transmitting the packet to the network.

In one of exemplary embodiments of the present disclosure, the data flow control method, suitable for an SDN controller connecting to a network, wherein the network includes a first OpenFlow switch, a second OpenFlow switch, and a plurality of Ethernet switches, includes but not limited to the steps of: monitoring a connection between the first OpenFlow switch and the second OpenFlow switch; calculating to derive a data path of the connection according the connection and a network structure of the network; and transmitting a plurality of action rules to the first OpenFlow switch and the second OpenFlow switch and transmitting a plurality of control signals to update a static forwarding table stored in each of the Ethernet switches on the data path, wherein, each of the action rules includes a condition and an action, and the action of a first action rule of the action rules includes: substituting a first flow address for a MAC address of a packet that satisfies the condition of the first action rule, and transmitting the packet to the network.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a block diagram illustrating the system structure of an ECOE network system according to an exemplary embodiment of the present disclosure.

FIG. 2 is a block diagram illustrating an OpenFlow switch according to an exemplary embodiment of the present disclosure.

FIG. 3 is a flow chart of a method for packet exchanging according to an exemplary embodiment of the present disclosure.

FIG. 4 is a block diagram illustrating the system structure of an ECOE network system according to an exemplary embodiment of the present disclosure.

FIG. 5 is a schematic diagram illustrating the data path of packet forwarding of network function virtualization.

FIG. 6 is a block diagram illustrating the system structure of an ECOE network system according to an exemplary embodiment of the present disclosure.

FIG. 7 is a block diagram illustrating an SDN controller according to an exemplary embodiment of the present disclosure.

FIG. 8 is a flow chart of a data flow control method according to an exemplary embodiment of the present disclosure.

### DETAILED DESCRIPTION OF DISCLOSED EMBODIMENTS

Reference will now be made in detail to the present exemplary embodiments of the disclosure, examples of which are illustrated in the accompanying drawings. Wherever possible, the same reference numbers are used in the drawings and the description to refer to the same or like parts.

The present disclosure aims to provide an Ethernet-Core-OpenFlow-Edge (hereafter referred as “ECOE”) network system structure, so that the OpenFlow network could not only coexist with an Ethernet network, but the packets could also be transmitted through the Ethernet network in an OpenFlow manner That is, the ECOE network structure could also provide network functions which provided by the OpenFlow network structure, such as flow based routing, unicasting, multi-casting/broadcasting, dynamic load balance and service chain. The network structure of the ECOE network system and the functions provided thereof would be described below in detail.

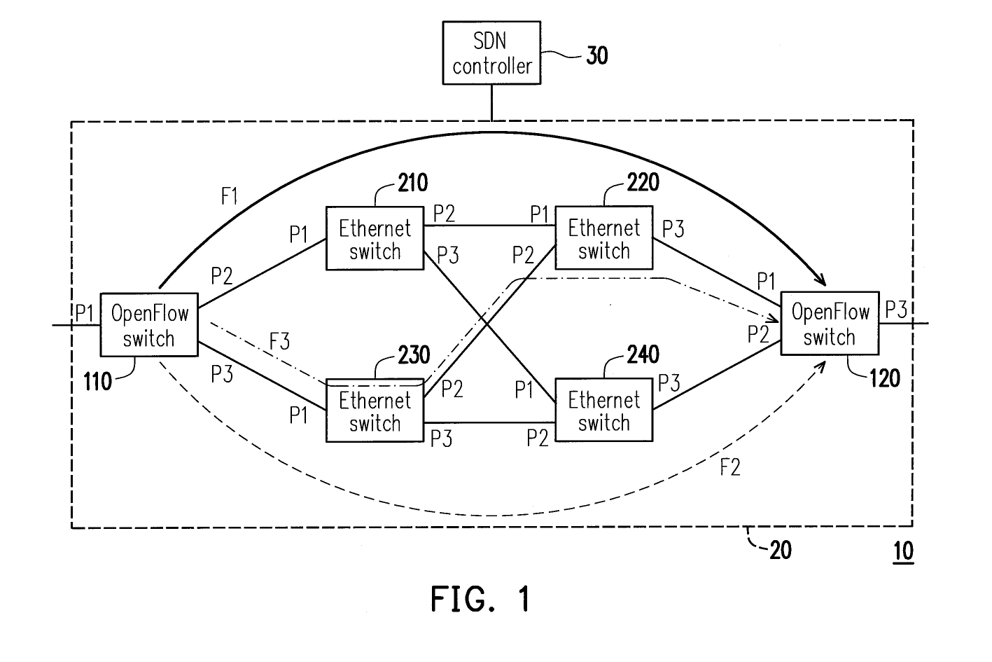

FIG. 1 is a block diagram illustrating the system structure of an ECOE network system according to an exemplary embodiment of the present disclosure. Referring to FIG. 1, the ECOE network system 10 includes a network 20 and an SDN controller 30. The network 20 may at least include OpenFlow switches 110-120 and Ethernet switches 210-240, wherein the OpenFlow switches 110-120 are configured at the edge of the network 20, whereas the Ethernet switches 210-240 are configured at the core of the network 20. Each of the OpenFlow switches 110-120 and the Ethernet switches 210-240 has a plurality of ports (e.g., the ports P1-P3 of the Ethernet switches 210-240), so that the OpenFlow switches 110-120 and the Ethernet switches 210-240 could be connecting to each other through ports of the OpenFlow switches 110-120 and the Ethernet switches 210-240. As a result, the OpenFlow switch 110 could be connecting to the OpenFlow switch 120 through the Ethernet switches 210-240. Moreover, the OpenFlow switches 110-120 (which are configured at the edge of the network 20) could also be connecting to another network (e.g., an OpenFlow network or another ECOE network) or an electronic device (e.g., a personal computer, a laptop computer, a smartphone or a table computer etc.) through the ports thereof (e.g., the port P1 of the OpenFlow switch 110, or port P3 of the OpenFlow switch 120). In addition, the OpenFlow switches 110-120 described herein could be a physical switch with SDN functions, or an virtual switch (e.g., an Open vSwitch) that is configured on an electronic device (e.g., one of the electronic devices mentioned above), the disclosure is not limited thereto.

The SDN controller 30 would be connecting to all the network devices the network 20 including the OpenFlow switches 110-120 (e.g., the SDN controller couples to a network unit of the OpenFlow switch 110) and the Ethernet switches 210-240 through an in-band manner or an out-band manner. Each of the Ethernet switches 210-240 would store a static forwarding table and when a packet is received by one of the Ethernet switches 210-240, the Ethernet switch received the packet may transmit the packet to a corresponding port of the Ethernet switch according to the static forwarding table (i.e., routing according to the static forward table). In the ECOE network system 10 described in the present exemplary embodiment, the SDN controller 30 would not only be able to transmit action rules to the OpenFlow switches 110-120, but also could be able to update the static forwarding table of the Ethernet switches 210-240 due to routing needs by sending a plurality of control signals to the Ethernet switches 210-240 (e.g., through Simple Network Management Protocol (SNMP) or Command Line Interface (CLI)). The examples of simultaneously transmitting the action rules to the OpenFlow switches 110-120 and the updating the static forwarding table of the Ethernet switches 210-240 would be clearly described later in this disclosure.

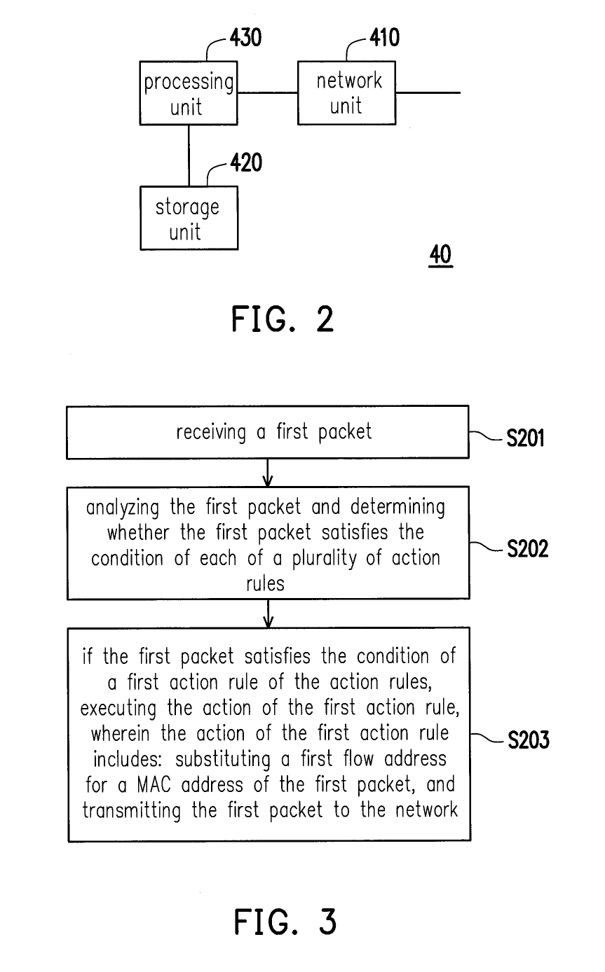

FIG. 2 is a block diagram illustrating an OpenFlow switch according to an exemplary embodiment of the present disclosure, and the OpenFlow switch depicted in FIG. 2 may correspond to the OpenFlow switch 110-120 shown in FIG. 1. Referring to FIG. 2, the OpenFlow switch 40 includes a network unit 410, a storage unit 420 and a processing unit 430. The network unit 410 is connecting to a network (e.g., the network 20 shown in FIG. 1) through a plurality of ports (not be shown in figure), wherein the network may include a plurality of Ethernet switches and at least one OpenFlow switch. The storage unit 420 is coupled to the processing unit 430 and stores a flow table, wherein the flow table includes a plurality of action rules, and each of the action rules includes a condition and an action. The processing unit 430 is coupled to the network unit 410 and the storage unit 420. When the processing unit 430 receives a first packet (e.g., receives the first packet from a personal computer connected to the network unit 410 of the OpenFlow switch 40), the processing unit 430 analyzes the first packet, and determines whether the first packet satisfies the condition of each of the action rules. If the processing unit determines that the first packet satisfies the condition of one of the action rules, e.g., a first action rule of the action rules, the processing unit 430 executes the action of the first action rule, wherein the action of the first action rule includes: substitutes a first flow address for a destination media access control (MAC) address of the first packet, and transmits the first packet to the network through the network unit 410.

FIG. 3 is a flow chart of a method for packet exchanging according to an exemplary embodiment of the present disclosure, wherein the method would be suitable for an OpenFlow switch (e.g., the OpenFlow switch 40 shown in FIG. 2) that is connecting to a network including a plurality of Ethernet switches and also at least one OpenFlow switch. Referring to FIG. 3, the method for packet exchanging may includes but not limited to the steps of: receiving a first packet (step S201); analyzing the first packet and determining whether the first packet satisfies the condition of each of a plurality of action rules (step S202); and if the first packet satisfies the condition of a first action rule of the action rules, executing the action of the first action rule, wherein the action of the first action rule includes: substituting a first flow address for a destination media access control (MAC) address of the first packet, and transmitting the first packet to the network (step S203).

In brief, in order to transmit packet through the Ethernet switches 210-240, for example, from the OpenFlow switch 110 to the OpenFlow switch 120, the OpenFlow switch 110 would first set the destination MAC address of the packet into a flow address according to the action rules in the flow table, so that the packet (i.e., the first packet) could flow in a data path that is determined by the SDN controller 30. The flow address would correspond to a unique flow ID that represents a specific data path assigned by the SDN controller 30, and each of the action rules may correspond to different flow address (i.e., different flow ID and different data path). And when the OpenFlow switch 120 receives the packet mentioned above (i.e., the packet with destination MAC address as the flow address), according to the flow table, the OpenFlow switch 120 may determine that the destination MAC address of the received packet is the flow address instead of the original destination MAC address of the packet (i.e., satisfies a condition of one of the action rules). As a result, the OpenFlow switch 120 may set the destination MAC address of the received packet back to the original MAC address (e.g., the MAC address of the OpenFlow switch 120, or the MAC address of an electronic device connected to the OpenFlow switch 120) according to the action rules.

Said two action rules (the first action rule that substitutes the flow address for the original MAC address of the packet; and the second action rule that substitutes the original MAC address for the flow address) are respectively stored in the flow table of the OpenFlow switch 110 and 120, and the two action rules are originally generated by the SDN controller 30, and the OpenFlow switch 110-120 may receive action rules from the SDN controller 30 (i.e., through the network unit of the OpenFlow switch 110-120 respectively). In the present exemplary embodiment, the SDN controller 30 may monitor connections between two OpenFlow switches (e.g., the OpenFlow switch 110-120). And then the SDN controller 30 may calculate to derive various data paths from the OpenFlow switch 110 to the OpenFlow switch 120 (or reverse) for packets of different usages or services.

Referring back to FIG. 1, assuming that the OpenFlow switch 110 receives a first packet with target TCP port 5601 and a second packet with target TCP port 9002, and the destination MAC address of both of the first and second packet are the MAC address of the OpenFlow switch 120 (or, the MAC address of an electronic device that connected to the OpenFlow switch 120). If the OpenFlow switch 110-120 are Ethernet switches, the network 20 would be an Ethernet network completely, and could only route the packets by using the source and destination MAC address recorded in the packet, and both the first packet and the second packet would be transmitted to the OpenFlow switch 120 (now in the example, the Ethernet Switch 120) via the same path (e.g., the data path F1 or the data path F2). In the present exemplary embodiment, since different target TCP port may correspond to different network services, the SDN controller 30 may set the target TCP port of the packets as the condition of one of (or part of) the action rules, so that packets of different network services could be routed in different data paths. For example, the SDN controller 30 may send action rules to OpenFlow switches 110-120, so that the flow table of OpenFlow switch 110-120 could be updated as the Table 1 and Table 2 shown below:

TABLE 1
Flow table of OpenFlow switch 110

| Condition | action |
|---|---|
| tp_dst = 5601 | actions = mod_dl_dst: Flow 1 |
| | output: 2 |
| tp_dst = 9002 | actions = mod_dl_dst: Flow 2, |
| | output: 3 |

TABLE 2
Flow table of OpenFlow switch 120

| condition | action |
|---|---|
| dl_dst = Flow1 | actions = mod_dl_dst: MAC(OpenFlow |
| | switch 120), output: P3 |
| dl_dst = Flow2 | actions = mod_dl_dst: MAC(OpenFlow |
| | switch 120), output: P3 |

And few examples the parameters and actions in the flow table are described in Table 3 below:

TABLE 3
Parameters and actions in flow table

| | meaning |
|---|---|
| Parameter | |
| tp_src | Source TCP port |
| tp_dst | Target TCP port |
| in_port | The physical port where the packet |
| | received from |
| dl_vlan | The vlan value of the packet |
| dl_src | Source MAC address of the packet |
| dl_dst | Destination MAC address of the packet |
| nw_src | Source IP address of the packet |
| | could be in format of “IP/netmask” |
| nw_dst | Destination IP address of the packet |
| | could be in format of “IP/netmask” |
| action | |
| mod_dl_src: X | Modify the source MAC address of the |
| | packet as X |
| mod_dl_dst: X | Modify the destination MAC address |
| | of the packet as X |
| Output: Y | Output the packet to port Y |
| mod_vlan_vid: Z | Modify the vlan value as Z |
| strip_vlan | Strip (zero) the vlan value |

And the static forwarding table of the Ethernet switch 210-240 could be updated simultaneously by the SDN controller 30 as:

TABLE 4

| | |
|---|---|
| Destination MAC address | Output port |

Static forwarding table of Ethernet switch 210

| | |
|---|---|
| Flow 1 | P2 |

Static forwarding table of Ethernet switch 220

| | |
|---|---|
| Flow 1 | P3 |

Static forwarding table of Ethernet switch 230

| | |
|---|---|
| Flow 2 | P3 |

Static forwarding table of Ethernet switch 240

| | |
|---|---|
| Flow 2 | P3 |

Referring to Table 1-4, as a result of updating the action rules of the OpenFlow switches 110-120 and the static forwarding table of the Ethernet switches 210-240 by the SDN controller 30, the OpenFlow switch 110 would determine that the first packet satisfies the condition of the first action rule listed on the flow table (i.e., “tp_dst=5601”), so the OpenFlow switch 110 modifies the destination MAC address of the first packet as a flow address “Flow 1”, and transmits the first packet to port P2 of the OpenFlow switch 110 that is connecting to the Ethernet switch 210. “Flow 1” is written as the form of a MAC address, and since the destination MAC address of the first packet is now “Flow 1”, the Ethernet switch 210 may transmit the first packet to port P2 of the Ethernet switch 210 according to the static forwarding table in the Ethernet switch 210 (refers to Table 4). Accordingly, the Ethernet switch 220 may also transmit the first packet to port P3 of the Ethernet switch 220 according to the static forwarding table of the Ethernet switch 220.

Similarly, the OpenFlow switch 110 would determine that the second packet satisfies the condition of the second action rule listed on the flow table (i.e., “tp_dst=9002”), so the OpenFlow switch 110 modifies the destination MAC address of the second packet as “Flow 2”, and transmits the second packet to port P3 of the OpenFlow switch 110 that is connected to the Ethernet switch 230. And then, since the destination MAC address of the second packet is now “Flow 2”, the Ethernet switch 230 may transmit the second packet to port P3 of the Ethernet switch 230 according to the static forwarding table of the Ethernet switch 230. Accordingly, the Ethernet switch 240 may also transmit the second packet to port P3 of the Ethernet switch 240 according to the static forwarding table of the Ethernet switch 240. When the OpenFlow switch 120 determines that the first packet and the second packet respectively satisfy the condition of the first and the second action rules in the flow table, the OpenFlow switch 120 (precisely, the processing unit of the OpenFlow switch 120) would modify the destination MAC address of the first packet and the second packet back to the MAC address of the OpenFlow switch 120 (i.e., the original destination MAC address of the first packet and the second packet, see action of in Table 2).

As a result, the first packet could be transmitted from the OpenFlow switch 110 to the OpenFlow 120 through the data path F1 and the second packet could be transmitted from the OpenFlow switch 110 to the OpenFlow 120 through the data path F2, the function of flow-based unicast routing described in typical OpenFlow network could be achieved in ECOE network system 10 described in the present disclosure. Also, said flow-based unicast routing could be also executed based on the determination of other information of the packet (e.g., the first packet and the second packet described above), such as depicted in Table 3, the port of the network unit receiving the packet, a target TCP port of the packet (as described in the exemplary embodiment above), a vlan value of the packet, a source MAC address of the packet, the destination MAC address of the first packet, a source IP address of the first packet, a destination IP address of the first packet, a source port of the first packet and/or a destination port of the first packet, and the information mentioned above could independently or jointly set as the condition of an action rule. For example, the SDN controller 30 may update the action rules of the OpenFlow switch 110-120 based on subnet of source IP address. In comparison with the example described above, the SDN controller 30 may simply update the flow table of the OpenFlow switch 110 from replacing Table 1 to Table 5 in below:

TABLE 5
Flow table of OpenFlow switch 110

| Condition | Action |
|---|---|
| nw_src = 10.10.10.0/24 | actions = mod_dl_dst: Flow 1, |
| | output: P2 |
| nw_src = 10.10.20.0/24 | actions = mod_dl_dst: Flow 2, |
| | output: P3 |

In the ECOE network system structure, the function of dynamic traffic engineering/dynamic load balance can be implemented by updating the static forwarding table of the Ethernet switches 210-240 in the network 20. For example, in the exemplary embodiment described above, the first packet and the second packet are to be transmitted from the OpenFlow switch 110 to the OpenFlow 120 respectively through the data path F1 and the data path F2, and when the SDN controller 30 detects that there's a congestion happened in the Ethernet switch 240, the SDN controller 30 may update the static forwarding table of the Ethernet switch 220 and 230 as:

TABLE 6

| | |
|---|---|
| Destination MAC address | Output port |

Static forwarding table of Ethernet switch 220

| | |
|---|---|
| Flow 1 | P3 |
| Flow 2 | P3 |

Static forwarding table of Ethernet switch 230

| | |
|---|---|
| Flow 2 | P2 |

As a result, the second packet then can be transmitted from the OpenFlow switch 110 to the OpenFlow 120 through the data path F3, so as to avoid the congestion in the Ethernet switch 240. By applying the same concept described above, the function of dynamic traffic engineering can also be achieved in the ECOE network system structure.

It is noted that the disclosure is not limited to the structure of the network system 10 shown in FIG. 1, the structure of the ECOE network system 10 may include more Ethernet switches at the core of the network and more OpenFlow switches at the edge of the network due to practical needs. In one exemplary embodiment of the present disclosure, the core of the network 20 may also include OpenFlow switches that are connected to other Ethernet switches. Since the OpenFlow switch would be capable of analyzing action rules sent from the SDN controller 30, it is easier to adapt an OpenFlow switch at the core of the ECOE network system structure. For example, assuming that the Ethernet switch 210 is now replaced by an OpenFlow switch (which could be an OpenFlow switch identical to OpenFlow switch 110), the SDN controller 30 needs only to update the flow table of the OpenFlow switch as the Table 7 described below, then the data path F1 would not be affected thereby.

TABLE 7
Flow table of the OpenFlow switch
replacing the Ethernet switch 110

| Condition | Action |
|---|---|
| dl_dst = Flow 1 | actions = output: P2 |

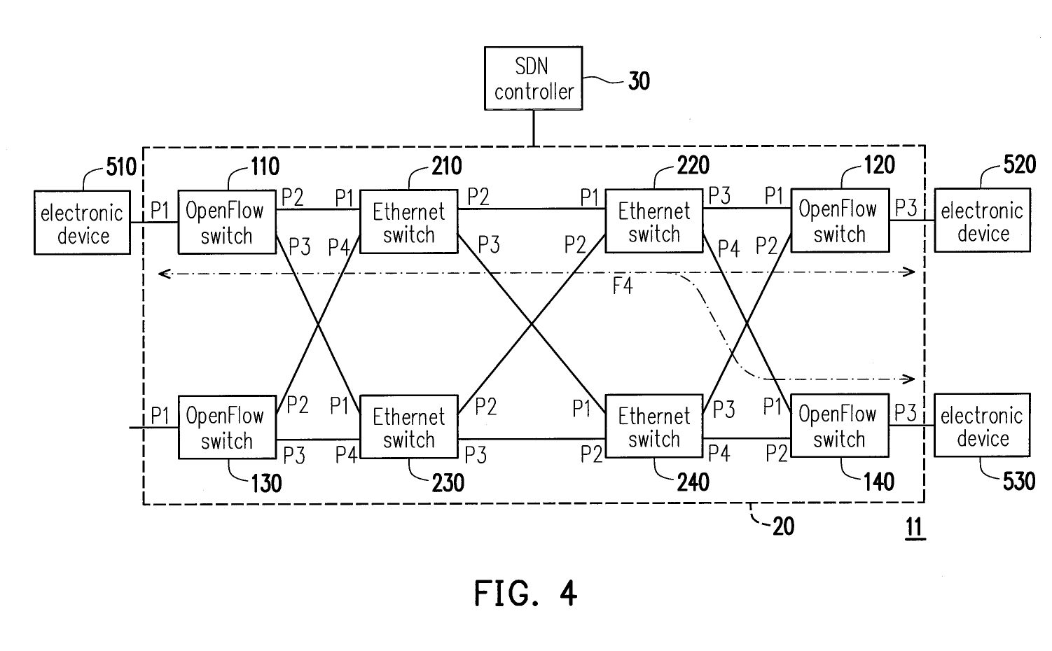

Moreover, an example relates to multicasting/broadcasting in the ECOE network would be introduced herein. FIG. 4 is a block diagram illustrating the system structure of an ECOE network system according to an exemplary embodiment of the present disclosure. Referring to FIG. 4, comparing to the network system 10 depicted in FIG. 1, in the present exemplary embodiment, the ECOE network system 11 further includes the OpenFlow switch 130 and the OpenFlow switch 140, wherein the OpenFlow switch 130 is respectively connecting to the port P4 of the Ethernet switch 210 and the port P4 of the Ethernet switch 230 through port P2 and P3 thereof, and the OpenFlow switch 140 is respectively connecting to the port P4 of the Ethernet switch 220 and the port P4 of the Ethernet switch 240 through port P1 and P2 thereof. In addition, the electronic devices 510-530 are connecting to the OpenFlow switches 110, 120 and 140 respectively.

In this exemplary embodiment, the ECOE network system 11 may implement the function of multicasting/broadcasting by modifying a vlan value of a broadcasting packet when receiving. For example, assuming that the electronic device 510-530 that respectively are connecting to the OpenFlow switches 110, 120 and 140 are in the same multicast group. Then, the SDN controller 30 may update the flow table of the OpenFlow switches 110, 120 and 140 and vlan tables of the Ethernet switches 210-220 as Table 8-11 shown in below:

TABLE 8
Flow table of OpenFlow switch 110

| Condition | Action |
|---|---|
| ln_port = P1, | actions = mod_vlan_vid: 100, |
| nw_dst = 226.139.1.2 | output: P2 |
| ln_port = P2, dl_vlan = 100 | actions = strip_vlan, output: P1 |
| nw_dst = 226.139.1.2 | |

TABLE 9
Flow table of OpenFlow switch 120

| Condition | Action |
|---|---|
| ln_port = P3, | actions = mod_vlan_vid: 100, |
| nw_dst = 226.139.1.2 | output: P1 |
| ln_port = 1, dl_vlan = 100 | actions = strip_vlan, output: P3 |
| nw_dst = 226.139.1.2 | |

TABLE 10
Flow table of OpenFlow switch 140

| Condition | Action |
|---|---|
| ln_port = P3, | actions = mod_vlan_vid: 100, |
| nw_dst = 226.139.1.2 | output: P1 |
| ln_port = 1, dl_vlan = 100 | actions = strip_vlan, output: P3 |
| nw_dst = 226.139.1.2 | |

TABLE 11

| | |
|---|---|
| VLAN | Output port |

vlan table of Ethernet switch 210

| | |
|---|---|
| 100 | P1, P2 |

vlan table of Ethernet switch 220

| | |
|---|---|
| 100 | P1, P3, p4 |

When the OpenFlow switch 110 receives a broadcast packet (i.e., the packet with destination IP address of the broadcast IP address “226.139.1.2”, and the OpenFlow switch 110-120 could identify the broadcast IP address through looking up the flow table or other information stored in the OpenFlow switch 110-120) from port P1 (i.e., from the electronic device 510), the OpenFlow switch 110 would modify the vlan value of the broadcast packet as “100” (i.e., a first value that presets to indicate that the packet is a broadcasting packet), and then transmit the broadcasting packet through part or all of the ports of the OpenFlow switch 110 according to the action rule (e.g., port P2 in this exemplary embodiment). On the other hand, when the OpenFlow switch 110 receives a broadcast packet with vlan value equals to “100” from port P2 (i.e., from the Ethernet switch 210), the OpenFlow switch 110 would strip off the vlan value and then transmit the broadcasting packet to port P1 (i.e., the electronic device 510).

Similarly, When the OpenFlow switch 120 receives a broadcast packet from port P3 (i.e., from the electronic device 520), the OpenFlow switch 120 would modify the vlan value of the broadcast packet as “100”, and then transmit the broadcasting packet through port P1. On the other hand, when the OpenFlow switch 120 receives a broadcast packet with vlan value equals to “100” from port P1 (i.e., from the Ethernet switch 220), the OpenFlow switch 120 would strip off the vlan value and then transmit the broadcasting packet to port P3 (i.e., the electronic device 520). When the OpenFlow switch 140 receives a broadcast packet from port P3 (i.e., from the electronic device 530), the OpenFlow switch 140 would modify the vlan value of the broadcast packet as “100”, and then transmit the broadcasting packet through port P1. On the other hand, when the OpenFlow switch 140 receives a broadcast packet with vlan value equals to “100” from port P1 (i.e., from the Ethernet switch 220), the OpenFlow switch 140 would strip off the vlan value (i.e., set vlan value to zero or null) and then transmit the broadcasting packet to port P3 (i.e., the electronic device 530).

For the Ethernet switches 210 and 220, the Ethernet switches 210 would forward all the packet with vlan value equals to “100” to port P1, P2, whereas the Ethernet switches 220 would forward all the packet with vlan value equals to “100” to port P1, P3 and P4 except the port received the packet. As a result, the packet sent from one of the OpenFlow switches in the multicast group (i.e., the OpenFlow switches 110, 120 and 140), would be forwarded to the rest of the OpenFlow switches in the multicast group (be forward to the corresponding ports, i.e., following the data path F4). Also, the members of the multicast group could be easily defined by the SDN controller 30.

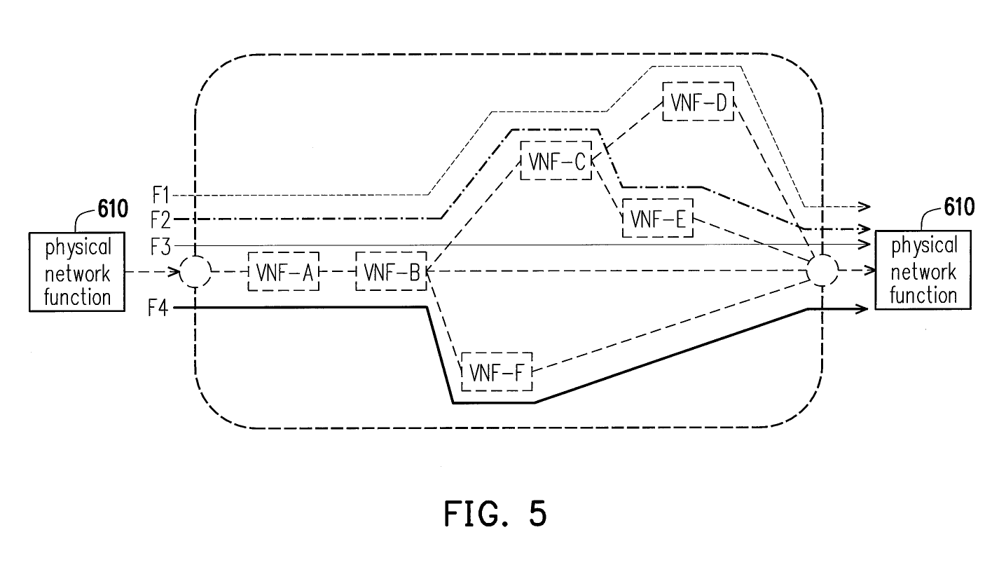

In one exemplary embodiment of the present disclosure, the ECOE network system structure could be also used in network function virtualization of telecommunication service providers, since the function of service chain and service chain load balancing could also be implemented in the ECOE network system structure. FIG. 5 is a schematic diagram illustrating the data path of packet forwarding of network function virtualization. Referring to FIG. 5, for the telecommunication service providers, the network functions (e.g., VNF-A to VNF-F) are virtually operating on different virtual machines respectively. The packets would be sent into the physical network function 610 first, and for customers with different needs, the packets correspond to different customers would be processed with different network functions respectively. For example, data paths F1-F4 are four flows corresponds to the packets of four kinds of customers. And the ECOE network system structure disclosed in the present disclosure could provide the function of arranging the flows to pass by different network functions. (e.g., VNF-A to VNF-F).

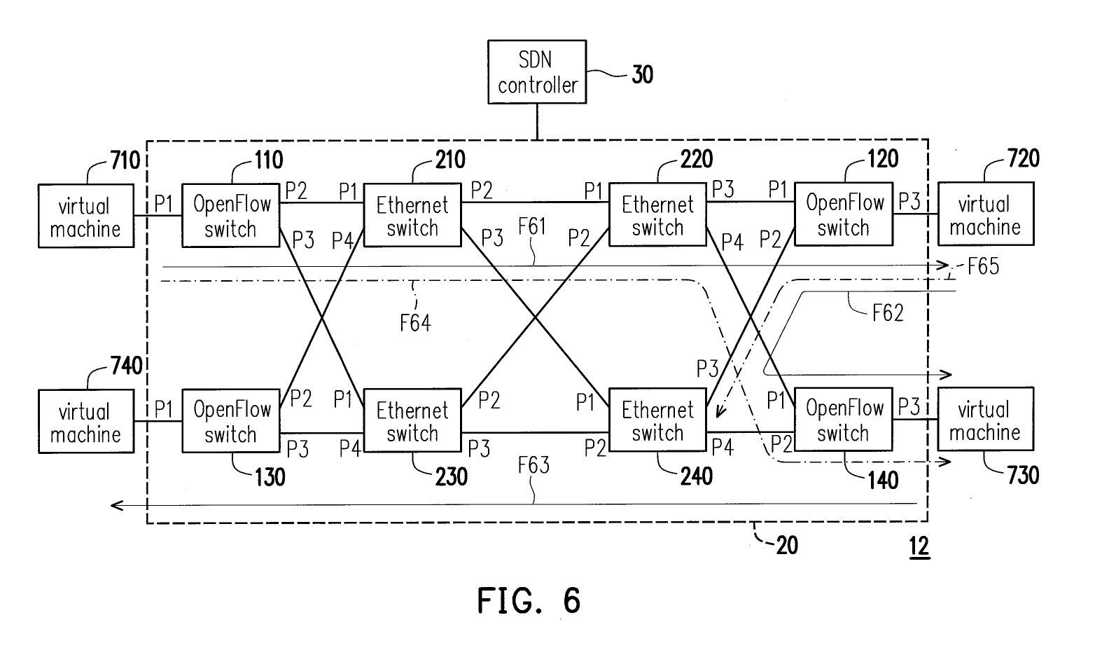

FIG. 6 is a block diagram illustrating the system structure of an ECOE network system according to an exemplary embodiment of the present disclosure. The ECOE network system 12 depicted in FIG. 6 has a network structure same with the ECOE network system 11 depicted in FIG. 5, but in FIG. 6, the OpenFlow switches 110-140 is connecting to virtual machines 710, 720, 740 and 730 respectively, and each of the virtual machines 710-740 may operates the network function as described in FIG. 5 (e.g., VNF-A to VNF-F depicted in FIG. 5). For example, each of the virtual machines 710-740 respectively operates the network function VNF-A, VNF-B, VNF-C and VNF-D, and the data path F61-F63 shown in FIG. 6 may represent the data path from VNF-A to VNF-D of data path F1 in FIG. 5.

Referring to FIG. 6, assuming that the data path F1 depicted in FIG. 5 corresponds to packets with target TCP port equals to 5601 (i.e., “tp_des=5601”), in order to forward packets received from virtual machine 710 following the data paths F61-F63, the SDN controller 30 may set the flow table of the OpenFlow switches 110-140, and the static forwarding table of the Ethernet switches 210-240 as the Tables 12-16 below:

TABLE 12
Flow table of OpenFlow switch 110

| Condition | Action |
|---|---|
| ln_port = P1, tp_dst = 5601 | actions = mod_dl_dst: Flow 1, |
| | output: P2 |

TABLE 13
Flow table of OpenFlow switch 120

| Condition | Action |
|---|---|
| dl_dst: Flow 1 | mod_dl_dst: (MAC address of |
| | virtrual machine 720) |
| | output: P3 |
| In_port = 3, tp_dst = 5601 | actions = mod_dl_dst: Flow 2, |
| | output: P2 |

TABLE 14
Flow table of OpenFlow switch 140

| Condition | Action |
|---|---|
| dl_dst: Flow 2 | mod_dl_dst: (MAC address of |
| | virtrual machine 730) |
| | output: P3 |
| In_port = 3, tp_dst = 5601 | actions = mod_dl_dst: Flow 3, |
| | output: P2 |

TABLE 15
Flow table of OpenFlow switch 130

| Condition | Action |
|---|---|
| dl_dst: Flow 3 | mod_dl_dst: (MAC address of |
| | virtrual machine 740) |
| | output: P1 |

TABLE 16

| | |
|---|---|
| MAC | Output port |

Static forwarding table of Ethernet switch 210

| | |
|---|---|
| Flow 1 | P3 |

Static forwarding table of Ethernet switch 220

| | |
|---|---|
| Flow 1 | P3 |

Static forwarding table of Ethernet switch 240

| | |
|---|---|
| Flow 2 | P4 |
| Flow 3 | P2 |

Static forwarding table of Ethernet switch 230

| | |
|---|---|
| Flow 3 | P4 |

As a result, the packets with target TCP port of 5601 may follow the flows F61-F63, to visit virtual machines 710-740 sequentially. Furthermore, in one exemplary embodiment of the present disclosure in application of the network function virtualizations, the ECOE network system 12 may also support the function of service chain load balancing. For example, the virtual machines 720 and 730 executes the same network functions (e.g., VNF-C1 and VNF-C2, wherein VNF-C1 and VNF-C2 are identical to VNF-C shown in FIG. 5), and the virtual machines 720 and 730 are built to distribute the load of executing the network function VNF-C on one single virtual machine. In this exemplary embodiment, the SDN controller 30 may add the source IP address as a condition of the action rule to forward packets with certain source IP address to the virtual machine 730 instead of the virtual machine 720 (i.e., the data path F64), and the packets transmitted from the virtual machine 720 would be forward to the virtual machine 740 without passing through the virtual machine 730 (i.e., the data path F65). To achieve the function of service chain load balancing as the flows (i.e., the data paths F61-F65) described above, the SDN controller 30 needs to update the flow table of the OpenFlow switches 110, 120 and 140, and the static forwarding table of the Ethernet switches 210, 220 and 240 as follows (wherein the flow table of the OpenFlow switches 130 and the static forwarding table the Ethernet switch 230 would maintain the same with Table 15 and Table 16):

TABLE 17
Flow table of OpenFlow switch 110

| Condition | Action |
|---|---|
| ln_port = P1, tp_dst = 5601 | actions = mod_dl_dst: Flow 1, |
| | output: P2 |
| ln_port = P1, tp_dst = 5601, | actions = mod_dl_dst: Flow 2, |
| nw_src = 140.96.1.1/16 | output: P2 |

TABLE 18
Flow table of OpenFlow switch 120

| Condition | Action |
|---|---|
| dl_dst: Flow 1 | mod_dl_dst: (MAC address of |
| | virtrual machine 720) |
| | output: P3 |
| In_port = 3, tp_dst = 5601 | actions = mod_dl_dst: Flow 3, |
| | output: P2 |

TABLE 19
Flow table of OpenFlow switch 140

| Condition | Action |
|---|---|
| dl_dst: Flow 2 | mod_dl_dst: (MAC address of |
| | virtrual machine 730) |
| | output: P3 |
| In_port = 3, tp_dst = 5601 | actions = mod_dl_dst: Flow 3, |
| | output: P2 |

TABLE 20

| | |
|---|---|
| MAC | Output port |

Static forwarding table of Ethernet switch 210

| | |
|---|---|
| Flow 1 | P2 |
| Flow 2 | P2 |

Static forwarding table of Ethernet switch 220

| | |
|---|---|
| Flow 1 | P3 |
| Flow 2 | P4 |

Static forwarding table of Ethernet switch 240

| | |
|---|---|
| Flow 3 | P2 |

It is noted that there are only some minor changes on the flow table of the OpenFlow switches 110, 120 and 140, and the static forwarding table of the Ethernet switches 210, 220 and 240 in comparison with the Table 12-14 and Table 16, so it could be concluded that it is easy for the ECOE network system 12 to change the data path of any packets.

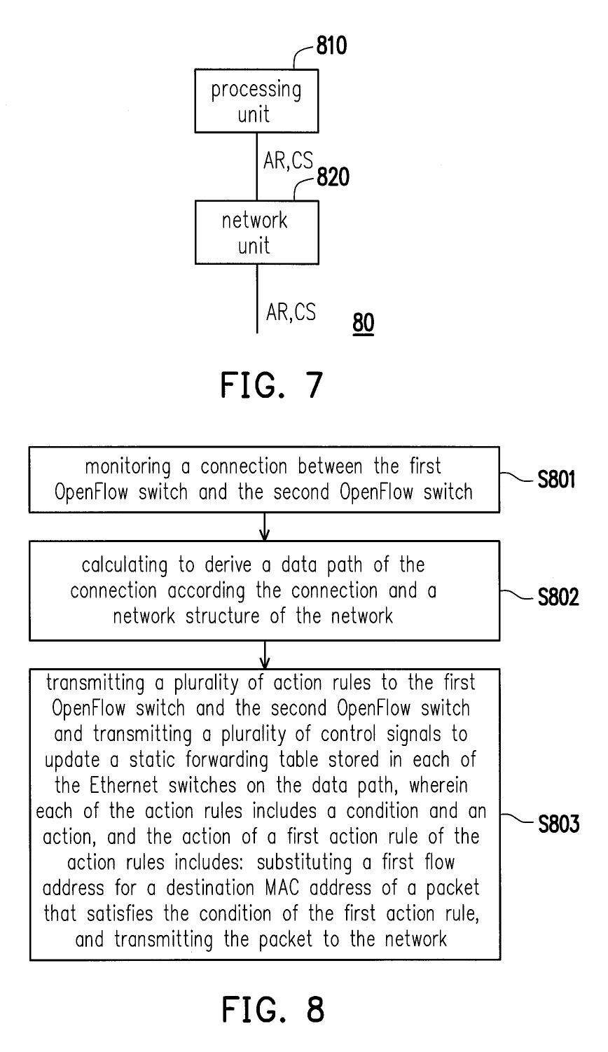

The present disclosure also discloses an SDN controller and a packet flow control method thereof. FIG. 7 is a block diagram illustrating an SDN controller according to an exemplary embodiment of the present disclosure, wherein the SDN controller could also be referred as the SDN controller 30 in FIG. 1, FIG. 4 and FIG. 6. Referring to FIG. 7, the SDN controller 80 includes a network unit 820 and a processing unit 810. The network unit 820 is connecting to a network through a plurality of ports (not be shown in figure), wherein the network includes a plurality of Ethernet switches, a first OpenFlow switch and a second OpenFlow switch (e.g., the network 20 in FIG. 1), wherein the first OpenFlow switch (e.g., the OpenFlow switch 110 in FIG. 1) and the second OpenFlow switch (e.g., the OpenFlow switch 120 in FIG. 1) are connecting through the Ethernet switches (e.g., the Ethernet switch 210-240 in FIG. 1). The processing unit 810 is coupled to the network unit 820.

Here in the present exemplary embodiment, the processing unit 810 monitors a connection between the first OpenFlow switch and the second OpenFlow switch through the network unit 820. The processing unit 810 calculates to derive a data path of the connection according the connection and a network structure of the network. And, through the network unit 820, the processsing unit 810 transmits a plurality of action rules AR to the first OpenFlow switch and the second OpenFlow switch and respectively transmits a plurality of control signals CS to update a static forwarding table stored in each of the Ethernet switches on the data path, wherein, each of the action rules includes a condition and an action. And the action of a first action rule of the action rules that is sent to the first OpenFlow switch may include: substituting a flow address for a destination media access control (MAC) address of a packet that satisfies the condition of the first action rule, and transmitting the packet to the network.

In one exemplary embodiment of the present disclosure, the condition of a second action rule of the action rules AR that is sent to the second OpenFlow switch by the SDN controller 80 may include: the destination MAC address of the packet is the flow address; and the action of the second action rule may include: substituting an original destination MAC address for the flow address according to the flow address.

As a result, the processing unit 810 of the SDN controller 80 may control the packets of the connection to flow in the data path dedicated by the SDN controller 80 from the first OpenFlow switch to the second OpenFlow switch by transmitting the action rules of the first and second OpenFlow switches and updating the static forwarding table of the Ethernet switches connected between the first and second OpenFlow switches through the network unit 820 of the SDN controller 80, and vice versa. Also, the destination MAC address of the packets arrived the second OpenFlow switches may also be transformed back to the original MAC address of the packets, so that the packets could be sent to the original destination (e.g., an electronic device connecting to the second OpenFlow switch) without any problem may be caused by the substitution of the destination MAC address of the packets.

FIG. 8 is a flow chart of a data flow control method according to an exemplary embodiment of the present disclosure, wherein the data flow control method is suitable for an SDN controller connecting to a network, wherein the network comprises a first OpenFlow switch, a second OpenFlow switch, and a plurality of Ethernet switches, e.g., the SDN controller shown in FIG. 1, FIG. 4, FIG. 6 and FIG. 7. referring to FIG. 8, the data flow control method includes the steps of: monitoring a connection between the first OpenFlow switch and the second OpenFlow switch (step S801); calculating to derive a data path of the connection according the connection and a network structure of the network (step S802); and transmitting a plurality of action rules to the first OpenFlow switch and the second OpenFlow switch and transmitting a plurality of control signals to update a static forwarding table store in each of the Ethernet switches on the data path, wherein, each of the action rules includes a condition and an action, and the action of a first action rule of the action rules includes: substituting a flow address for a destination media access control (MAC) address of a packet that satisfies the condition of the first action rule, and transmitting the packet to the network (step S803).

In one exemplary embodiment of the present disclosure, the condition of a second action rule of the action rules may include: the destination MAC address of the packet is the flow address; and the action of the second action rule may include: substituting an original destination MAC address for the flow address according to the flow address. And in this exemplary embodiment, the first action rule is sent to the first OpenFlow switch and the second action rules is sent to the second OpenFlow switch by the SDN controller. And the detailed description of the SDN controller and the data flow control method thereof can refer to the above-mentioned embodiments described in FIG. 1˜FIG. 6, which is omitted to describe herein.

In view of the aforementioned descriptions, the present disclosure provides a ECOE network system structure, including an OpenFlow switch and a packet exchanging method thereof, and an SDN controller and a data flow control method thereof, which provides network functions such as flow-based unicasting, multicasting/broadcasting, service chain of network function virtualization, service chain load balancing . . . etc that are to be provided in an OpenFlow network. Since the hardware cost of an OpenFlow switch is much higher than a conventional Ethernet switch, the ECOE network system structure provided in the present disclosure can achieve network functions in the OpenFlow network with less cost. Also, the ECOE network system structure provided in the present disclosure is not only a solution of coexisting the OpenFlow network and the existing network (e.g., the Ethernet), but also make it possible for an OpenFlow packet to be forwarded in a data path assigned by the SDN controller in a network with Ethernet switches at core, the problems when transforming the existing network into the OpenFlow network would be solved thereby.

No element, act, or instruction used in the detailed description of disclosed embodiments of the present application should be construed as absolutely critical or essential to the present disclosure unless explicitly described as such. Also, as used herein, each of the indefinite articles “a” and “an” could include more than one item. If only one item is intended, the terms “a single” or similar languages would be used. Furthermore, the terms “any of” followed by a listing of a plurality of items and/or a plurality of categories of items, as used herein, are intended to include “any of”, “any combination of”, “any multiple of”, and/or “any combination of multiples of the items and/or the categories of items, individually or in conjunction with other items and/or other categories of items. Further, as used herein, the term “set” is intended to include any number of items, including zero. Further, as used herein, the term “number” is intended to include any number, including zero.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

Moreover, the claims should not be read as limited to the described order or elements unless stated to that effect. In addition, use of the term “means” in any claim is intended to invoke 35 U.S.C. §112, ¶6, and any claim without the word “means” is not so intended.

What is claimed is:

1. An OpenFlow switch, comprising:
a network unit, connecting to a network, wherein the network comprises a plurality of Ethernet switches;
a storage unit, coupled to the network unit, stores a flow table, wherein the flow table comprises a plurality of action rules, and each of the action rules comprises a condition and an action;
a processing unit, coupled to the network unit and the storage unit,
wherein the processing unit receives a first packet, the processing unit analyzes the first packet and determines whether the first packet satisfies the condition of each of the action rules; and
if the processing unit determines that the first packet satisfies the condition of a first action rule of the action rules, the processing unit executes the action of the first action rule, wherein the action of the first action rule comprises:
substitutes a first flow address for a destination media access control (MAC) address of the first packet, and transmits the first packet to the network through the network unit.

2. The OpenFlow switch of claim 1, wherein:
the processing unit receives a second packet from the network through the network unit, the processing unit determines whether the second packet satisfies the condition of a second action rule of the action rules, wherein the condition of the second action rules comprises:
a destination MAC address of the second packet is a second flow address; and
if the processing unit determines that the second packet satisfies the condition of the second action rule, the processing unit executes the action of the second action rule, wherein the action of the second action rule comprises:
substituting an original destination MAC address for the second flow address according to the second flow address.

3. The OpenFlow switch of claim 1, wherein:
the network unit further couples to an SDN controller; and
the processing unit receives the action rules from the SDN controller through the network unit, and stores the action rules into the flow table in the storage unit.

4. The OpenFlow switch of claim 1, wherein:
the network unit is connecting to the network through a plurality of ports, wherein the ports comprises a first port and a second port; and
if the processing unit determines that a second packet received by the processing unit satisfies the condition of a second action rule of the action rules, the processing unit executes the action of the second action rule, wherein the action of the second action rule comprises:
transmits the second packet to the network through the first port of the network unit; and
if the processing unit determines that a third packet received by the processing unit satisfies the condition of a third action rule of the action rules, the processing unit executes the action of the third action rule, wherein the action of the third action rule comprises:
transmits the third packet to the network through the second port of the network unit.

5. The OpenFlow switch of claim 1, wherein:
the network unit is connecting to the network through a plurality of ports;
if the processing unit determines that a second packet received by the processing unit satisfies the condition of a second action rule of the action rules, the processing unit executes the action of the second action rule, wherein the condition of the second action rule comprises:
a destination IP address of the second packet matches a broadcast IP address stored in the flow table; and
the action of the second action rule comprises:
modifies a vlan value of the second packet as a first value; and
transmits the second packet to the network through part or all of the ports of the network unit.

6. The OpenFlow switch of claim 1, wherein,
the processing unit receives a second packet from the network through the network unit, the processing unit determines whether the second packet satisfies the condition of a second action rule of the action rules, wherein the second action rules comprises:
a destination IP address of the second packet matches a broadcast IP address stored in the flow table and a vlan value of the second packet is the first value; and
if the processing unit determines that the second packet satisfies the condition of the second action rule, the processing unit executes the action of the second action rule, wherein the action of the second action rule comprises:
strips the vlan value of the second packet.

7. The OpenFlow switch of claim 1, wherein,
each of the condition of the action rules corresponds to a port of the network unit receiving the first packet, a target TCP port of the first packet, a vlan value of the first packet, a source MAC address of the first packet, the destination MAC address of the first packet, a source IP address of the first packet, a destination IP address of the first packet, a source port of the first packet and/or a destination port of the first packet.

8. A method for packet exchanging, suitable for a OpenFlow switch that connects to a network comprising a plurality of Ethernet switches, comprising:
receiving a first packet;
analyzing the first packet and determining whether the first packet satisfies a condition of each of a plurality of action rules; and
if the first packet satisfies the condition of a first action rule of the action rules, executing the action of the first action rule, wherein the action of the first action rule comprises:
substituting a first flow address for a destination media access control (MAC) address of the first packet, and transmitting the first packet to the network.

9. The method of claim 8, wherein the method further comprises:
receiving a second packet from the network;
determining whether the second packet satisfies the condition of a second action rule of the action rules, wherein the condition of the second action rule comprises:
a destination MAC address of the second packet is a second flow address; and
if the second packet satisfies the condition of the second action rule, executing the action of the second action rule, wherein the action of the second action rule comprises:
substituting an original destination MAC address for the second flow address according to the second flow address.

10. The method of claim 8, wherein before the step of analyzing the first packet, the method further comprising:
receiving the action rules from a SDN controller; and
storing the action rules into a flow table.

11. The method of claim 8, wherein the method further comprising:
receiving a second packet and a third packet;
determining whether the second packet satisfies the condition of a second action rule of the action rules, if the second packet satisfies the condition of the second action rule, executing the action of the second action rule, wherein the action of the second action rule comprises:
transmitting the second packet to the network through a first port of a network unit of the OpenFlow switch; and
determining whether the third packet satisfies the condition of a third action rule of the action rules, if the third packet satisfies the condition of the third action rule, executing the action of the third action rule, wherein the action of the third action rule comprises:
transmitting the third packet to the network through a second port of the network unit of the OpenFlow switch.

12. The method of claim 8, wherein the method further comprising:
receiving a second packet;
determining whether the second packet satisfies the condition of a second action rule of the action rules, if the second packet satisfies the condition of the second action rule, executing the action of the second action rule, wherein the condition of the second action rule comprises:
a destination IP address of the second packet and a broadcast IP stored in a flow table is matched; and
the action of the second action rule comprises:
modifying a vlan value of the second packet as a first value; and
transmitting the second packet to the network through part or all of a plurality of ports of a network unit of the OpenFlow switch.

13. The method of claim 8, wherein the method further comprising:
receiving a second packet;
determining whether the second packet satisfies the condition of a second action rule of the action rules, if the second packet satisfies the condition of the second action rule, executing the action of the second action rule, wherein the condition of the second action rule comprises:
a destination IP address of the second packet and a broadcast IP stored in a flow table is matched and a vlan value of the second packet is a first value; and
the action of the second action rule comprises:
stripping the vlan value of the second packet.

14. The method of claim 8, wherein,
each of the condition of the action rules corresponds to a port of a network unit of the OpenFlow switch receiving the first packet, a target TCP port of the first packet, a vlan value of the first packet, a source MAC address of the first packet, the destination MAC address of the first packet, a source IP address of the first packet, a destination IP address of the first packet, a source port of the first packet and/or a destination port of the first packet.

15. A SDN controller, comprising:
a network unit, connecting to a network, wherein the network comprises a plurality of Ethernet switches, a first OpenFlow switch and a second OpenFlow switch, wherein the first OpenFlow switch and the second OpenFlow switch are connecting through the Ethernet switches;
and a processing unit, coupled to the network unit,
wherein, the processing unit monitors a connection between the first OpenFlow switch and the second OpenFlow switch through the network unit;
the processing unit calculates to derive a data path of the connection according the connection and a network structure of the network; and
through the network unit, the processsing unit transmits a plurality of action rule to the first OpenFlow switch and the second OpenFlow switch and transmits a plurality of control signals to update a static forwarding table stored in each of the Ethernet switches on the data path,
wherein, each of the action rules comprises a condition and an action, and the action of a first action rule of the action rules comprising:
substituting a first flow address for a destination media access control (MAC) address of a packet that satisfies the condition of the first action rule, and transmitting the packet to the network.

16. The SDN controller of claim 15, wherein:
the condition of a second action rule of the action rules comprises:
the destination MAC address of the packet is a second flow address; and
the action of the second action rule comprising:
substituting an original destination MAC address for the second flow address according to the second flow address.

17. The SDN controller of claim 15, wherein,
the action of a second action rule of the action rules comprises:
transmitting the packet through a first port of the first OpenFlow switch; and
the action of a third action rule of the action rules comprises:
transmitting the packet through a second port of the first OpenFlow switch.

18. The SDN controller of claim 15, wherein,
the condition of a second action rule of the action rules comprises:
a destination IP address of the packet matches a broadcast IP address; and
the action of the second action rule comprising:
modifying a vlan value of the packet as a first value; and
transmitting the packet to the network through part or all of a plurality of the first OpenFlow switch.

19. The SDN controller of claim 18, wherein,
the condition of a third action rule of the action rules comprises:
the destination IP address of the packet matches a broadcast IP address and the vlan value of the packet is the first value; and
the action of the third action rule comprises:
stripping the vlan value of the packet.

20. The SDN controller of claim 15, wherein,
each of the condition of the action rules corresponds to a port of the first OpenFlow switch or the second OpenFlow switch receiving the packet, a target TCP port of the packet, a vlan value of the packet, a source MAC address of the packet, the destination MAC address of the packet, a source IP address of the packet, a destination IP address of the packet, a source port of the packet and/or a destination port of packet.

21. A data flow control method, suitable for an SDN controller connecting to a network, wherein the network comprises a first OpenFlow switch, a second OpenFlow switch, and a plurality of Ethernet switches, comprising:
monitoring a connection between the first OpenFlow switch and the second OpenFlow switch;
calculating to derive a data path of the connection according the connection and a network structure of the network; and
transmitting a plurality of action rules to the first OpenFlow switch and the second OpenFlow switch and transmitting a plurality of control signals to update a static forwarding table stored in each of the Ethernet switches on the data path, wherein each of the action rules comprises a condition and an action, and the action of a first action rule of the action rules comprising:
substituting a first flow address for a destination media access control (MAC) address of a packet that satisfies the condition of the first action rule, and transmitting the packet to the network.

22. The data flow control method of claim 21, wherein:
the condition of a second action rule of the action rules comprises:
the destination MAC address of the packet is a second flow address; and
the action of the second action rule comprising:
substituting an original destination MAC address for the second flow address according to the second flow address.

23. The data flow control method of claim 21, wherein,
the action of a second action rule of the action rules comprises:
transmitting the packet through a first port of the first OpenFlow switch; and
the action of a third action rule of the action rules comprises:
transmitting the packet through a second port of the first OpenFlow switch.

24. The data flow control method of claim 21, wherein,
the condition of a second action rule of the action rules comprises:
a destination IP address of the packet matches a broadcast IP address; and
the action of the second action rule comprising:
modifying a vlan value of the packet as a first value; and
transmitting the packet to the network through part or all of a plurality of ports of the first OpenFlow switch.

25. The data flow control method of claim 24, wherein,
the condition of a third action rule of the action rules comprises:
the destination IP address of the packet matches the broadcast IP address and the vlan value of the packet is the first value; and
the action of the third action rule comprises:
stripping the vlan value of the packet.

26. The data flow control method of claim 21, wherein,
each of the condition of the action rules corresponds to a port of the first OpenFlow switch or the second OpenFlow switch receiving the packet, a target TCP port of the packet, a vlan value of the packet, a source MAC address of the packet, the destination MAC address of the packet, a source IP address of the packet, a destination IP address of the packet, a source port of the packet and/or a destination port of packet.
